(19) United States
(12) Patent Application Publication
(10) Pub. No.: US 2008/0049257 A1
(43) Pub. Date: Feb. 28, 2008

(54) METHOD AND APPARATUS FOR COMPENSATING FOR DISPLAY DISTORTION USING SCANNER AND DISPLAY SYSTEM ADOPTING THE METHOD AND APPARATUS

(75) Inventors: Jin-gil Jeong, Seoul (KR); Dae-sik Kim, Suwon-si (KR); Sang-hyun Sohn, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/835,444

(22) Filed: Aug. 8, 2007

(30) Foreign Application Priority Data
Aug. 24, 2006 (KR) 10-2006-0080642

(51) Int. Cl. G06K 15/02; H04N 1/36

(52) U.S. Cl. 358/3.26; 358/409

(57) ABSTRACT

Provided are a method and apparatus for compensating display distortion generated when the image is formed using the operational characteristic of a scanner. The method for compensating a display distortion in a display system includes: dividing a sync section where image data is output into a plurality of sections; setting a clock speed of the image data for each of the sections based on an operational characteristic of a scanner; and outputting the image data at a different clock speed for each divided section, the different clock speed reflecting a set clock speed for each divided section.

### CROSS-REFERENCE TO RELATED PATENT APPLICATIONS

This application claims the benefit of Korean Patent Application No. 10-2006-0080642, filed on Aug. 24, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to a laser projection display system, and more particularly, to a method and apparatus for compensating display distortion generated when the image is formed using the operational characteristic of a scanner and display system adopting the method and apparatus.

2. Description of the Related Art

Conventional image display units include CRTs (cathode ray tubes) for television sets or flat panel displays such as LCD (liquid crystal display) devices. However, the CRTs or LCD devices have disadvantages because large size screens are difficult to manufacture and, as the screen size increases, resolution decreases so that the size of a screen that can be realized is limited.

With the advent of a high information society and the rapid development of the multimedia industry, laser projection display devices have been highlighted as a device capable of providing a large screen and high brightness as well as high color representation close to natural color. The laser projection display device having the above merits uses a scanner to scan a laser beam emitted from a laser light source onto a screen.

In order to form an image on a screen, a laser beam must be scanned horizontally and simultaneously vertically. For a general HDTV (high-definition TV) image signal, specifications of data clock and other signals are determined according to resolution, and image processing is performed with a particular data clock value according to the resolution. For example, when the resolution is 1024, 1024 scanning lines must be scanned for one horizontal sync period. That is, the display device decodes a horizontal sync signal, a clock signal, and RGB data from a composite image signal and outputs the RGB data to an RGB laser driver at a particular clock speed.

However, in a display device using an MEMS (micro-electro-mechanical system) scanner, a laser beam is scanned by moving the MEMS scanner to the left and right. As the MEMS scanner moves, the MEMS performs a resonance operation. Also, a laser beam can be presented in gradation only when the laser beam is directly modulated or PWM (pulse width modulation) driven at a very high speed. The display device can present gradation only when a signal for modulation is transmitted to a laser driving circuit. The scanner does not perform a uniform motion. Instead, the scanner performs a non-uniform motion having a deviation in speed like a sine curve and accordingly leaves a portion at the left and right sides where an image is not displayed for a particular period of time. Thus, the scanner is not able to completely compensate for the linearity of a screen due to the non-uniform motion, and image distortion is generated.

### SUMMARY OF THE INVENTION

To address the above and/or other problems, the present invention provides a method for compensating a display distortion by controlling the output timing of a laser driving signal based on the scanning speed of a scanner in a laser projection display system.

The present invention provides an apparatus for compensating a display distortion by controlling the output timing of a laser driving signal based on the scanning operational characteristic of a scanner

The present invention provides a display system adopting the method and apparatus for compensating a display distortion.

According to an aspect of the present invention, there is provided a method for compensating a display distortion in a display system, the method including: dividing a sync section where image data is output into a plurality of sections; setting a clock speed of the image data for each of the sections based on an operational characteristic of a scanner; and outputting the image data at a different clock speed for each divided section, the different clock speed reflecting a set clock speed for each divided section.

According to another aspect of the present invention, there is provided a display system including: an image signal processing portion extracting a sync signal and image data from an input composite image signal and controlling output timing of the extracted image data based on an operational characteristic of the scanner; a light modulation portion modulating the brightness of a light source according to an image signal output from the image processing portion; and a scanner portion scanning a beam output from the light modulation portion onto a screen according to the sync signal generated by the image signal processing portion.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a laser projection display system according to an exemplary embodiment of the present invention;

FIG. 2 is a graph showing the operational characteristic of the scanner of FIG. 1;

FIG. 3 is a block diagram of the image signal processing portion of FIG. 2;

FIG. 4 is a block diagram of the timing processor of FIG. 3;

FIG. 5 is a flow chart for explaining the operation of the timing processor of FIG. 4;

FIGS. 6A and 6B are waveform diagrams of the line image data to which the conventional technology is applied;

FIGS. 6C and 6D are waveform diagrams of the line image data whose timing is modulated by the timing processor according to an exemplary embodiment of the present invention and the line image data based on the scanner;

FIG. 7 is a diagram of an exemplary embodiment of the memory control portion of FIG. 4;

FIG. 8 is a flow chart for explaining a method for compensating a display distortion according to an exemplary embodiment of the present invention;

FIG. 9A is images showing a conventional line image that is distorted because the operational characteristic of a scanner is not compensated; and

FIG. 9B is images showing a line image in which the operational characteristic of a scanner is compensated according to an exemplary embodiment of the present invention.

### DETAILED DESCRIPTION OF THE EXEMPLARY EMBODIMENTS

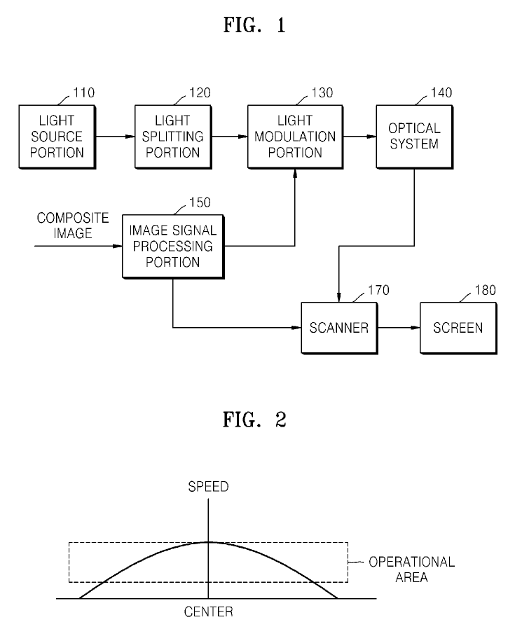

FIG. 1 is a block diagram of a laser projection display system according to an exemplary embodiment of the present invention. Referring to FIG. 1, a laser projection display system according to an exemplary embodiment of the present invention includes a light source portion 110, a light splitting portion 120, a light modulation portion 130, an optical system 140, an image processing portion 150, a scanner 170, and a screen 180. The light source portion 110 emits a laser beam to form light. The light splitting portion 120 consists of a plurality of dichroic mirrors and splits the light emitted from the light source portion 110 into red (R), green (G), and blue (B).

The image signal processing portion 150 extracts horizontal/vertical sync signals, a clock signal, and RGB image data from an input composite image signal and controls the output timing of the RGB image data based on the operational characteristic of the scanner 170. The image signal processing portion 150 outputs the RGB image data to the light modulation portion 130. That is, the image signal processing portion 150 divides a sync section from which the RGB image data is output into a plurality of particular sections, sets different data clock speeds for the respective sections based on the operational characteristic of the scanner 170, and reads and writes the image data at a clock speed set for each section. Also, the image signal processing portion 150 samples the RGB image data up and down into a signal corresponding to the resolution of a panel (not shown).

The light modulation portion 130 modulates the RGB light beams split by the light splitting portion 120 according to the RGB signals generated by the image signal processing portion 150. The optical system 140 synthesizes the light beams modulated by the light modulation portion 130 into a single beam using a dichroic mirror. The scanner 170 moves to the left and right according to the vertical sync signal and horizontal sync signal generated by the image signal processing portion 150 and simultaneously scans a beam output from the optical system 140 onto the screen 180.

FIG. 2 is a graph showing the operational characteristic of the scanner 170 of FIG. 1. Referring to FIG. 2, the speed of the scanner 170 varies according to the position of scanning. That is, the scanner 170 performs a non-uniform motion in an operation area in a dotted area, leaving portions at the left and right sides where an image is not displayed for a predetermined period of time. For example, the scanner 170 rotates at the maximum speed at the central position in the operational area and the speed of the scanner 170 decreases as it goes farther from the central position of the operation area.

FIG. 3 is a block diagram of the image signal processing portion 150 of FIG. 2. Referring to FIG. 3, the image signal processing portion 150 includes an image processor 310 and a timing processor 320. The image processor 310 extracts the horizontal/vertical sync signal, the clock signal, and the RGB image data from the composite image signal. The timing processor 320 stores the RGB image data on a memory according to the clock signal and horizontal/vertical sync signal extracted by the image processor 310 and reads out the stored RGB image data differently for each section according to a clock speed set to the speed of the scanner 170.

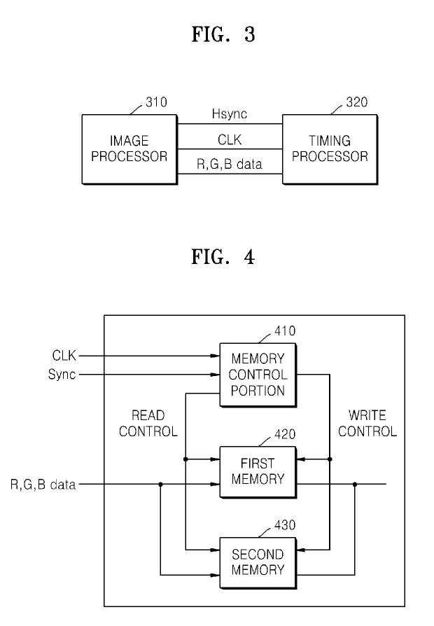

FIG. 4 is a block diagram of the timing processor 320 of FIG. 3. The timing processor 320 includes a memory control portion 410, a first memory 420, and a second memory 430. The first memory 420 and the second memory 430 store the RGB image data. The memory control portion 410 generates an address that reads and write the image data with respect to the first and second memories 420 and 430.

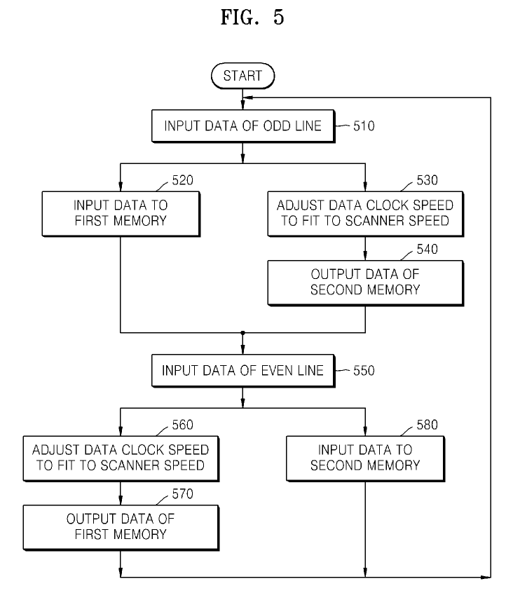

FIG. 5 is a flow chart for explaining the operation of the timing processor 320 of FIG. 4. Referring to FIG. 5, in the operation of the timing processor 320, first, the RGB image data of an odd line is input according to the clock signal and the sync signal (Operation 510). The memory control portion 410 writes the RGB image data of an odd line to the first memory 420 (Operation 520). The memory control portion 410 controls the data clock speed based on the scanner speed (Operation 530) and reads the RGB image data of the second memory 430 (Operation 540).

Next, the RGB image data of an even line is input according to the clock signal and sync signal (Operation 550). The memory control portion 410 writes the RGB image data of an even line to the second memory 430 (Operation 580). The memory control portion 410 controls the data clock speed based on the scanner speed (Operation 560) and reads the RGB image data of the first memory 430 (Operation 570).

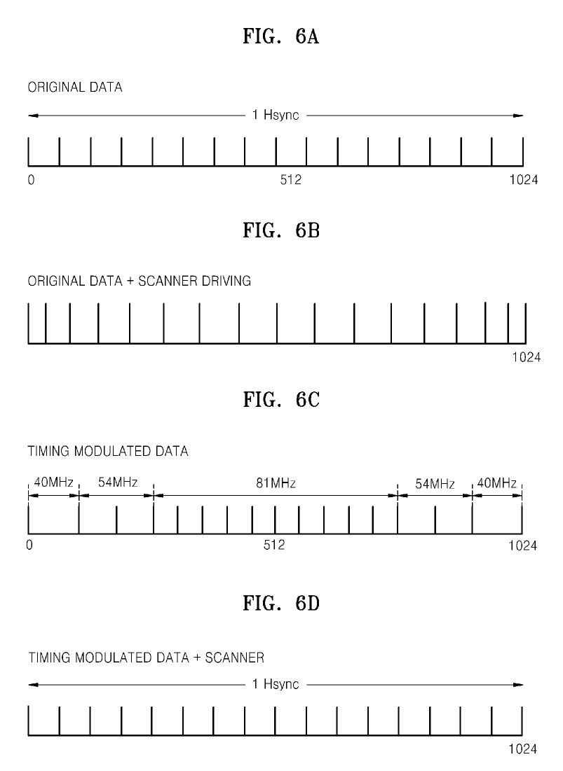

FIGS. 6A and 6B are waveform diagrams of the line image data to which the conventional technology is applied. Referring to FIG. 6A, the timing processor 320 outputs the image data of 1024 lines for one horizontal sync (1 Hsync) section at a constant clock speed. Referring to FIG. 6B, the line interval of the image data for the one horizontal sync (1 Hsync) section is not uniform due to the non-uniform characteristic of the scanner 170. That is, the image line interval increases at the central position while the image line interval decreases as it goes farther from the central position. Thus, display distortion is generated on the screen 180 due to the irregular image line interval.

FIGS. 6C and 6D are waveform diagrams of the line image data whose timing is modulated by the timing processor 320 according to an exemplary embodiment of the present invention and the line image data based on a characteristic of the scanner 170. Referring to 6C, the timing processor 320 divides into a plurality of sections the one Hsync section from which image data is output. The timing processor 320 sets the clock speed of the image data differently for the respective sections based on the operational characteristic of the scanner 170. For example, the data clock speed is set to 81 MHz in the central portion of the sync section and differently 40 MHz and 54 MHz in other portion except for the central portion according to the operational characteristic of the scanner 170.

Referring to FIG. 6D, as the image data is output at a different clock speed for each divided section based on the operational characteristic of the scanner 170, image data having a constant line interval is displayed on the screen 180 for the one Hsync section. Thus, the timing processor 320 reads the image data from the memories 420 and 430 at a variety of speeds to compensate the non-uniform motion of the scanner 170.

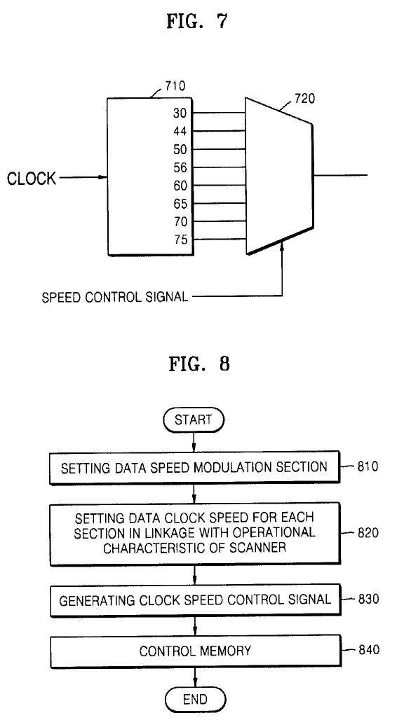

FIG. 7 is a diagram of an exemplary embodiment of the memory control portion 410 of FIG. 4. Referring to FIG. 7, the memory control portion 410 includes a phase locked loop (PLL) portion 710 and a multiplexer portion 720. The PLL portion 710 divides an external clock signal into a plurality of clock signals, for example, 30 MHz, 44 MHz, etc. The multiplexer portion 720 selects any of the clock signals generated by the PLL portion 710 according to the speed control signal of the data output timing divided for each sync section. Thus, the multiplexer portion 720 generates a clock signal that controls write and read addresses of the memories 420 and 430.

In another exemplary embodiment, the memory control portion 410 can control the address of the memories 420 and 430 by generating a variable clock by different voltages for each section using a voltage controlled oscillator (VCO).

FIG. 8 is a flow chart for explaining a method for compensating a display distortion according to an exemplary embodiment of the present invention. Referring to FIG. 8, first, the horizontal sync section where the image data is output is divided into a plurality of sections (Operation 810). The sections can be arbitrarily adjusted according to the performance of a system. Next, the clock speed of the image data is set for the respective sections based on the scanning operational characteristic of the scanner 170 (Operation 820). A clock speed control signal corresponding to the clock speed set for each section is generated (Operation 830). Then, the addresses of the memories 420 and 430 are controlled at different clock speeds for the respective sections that reflect the clock speed set for each divided section (Operation 840).

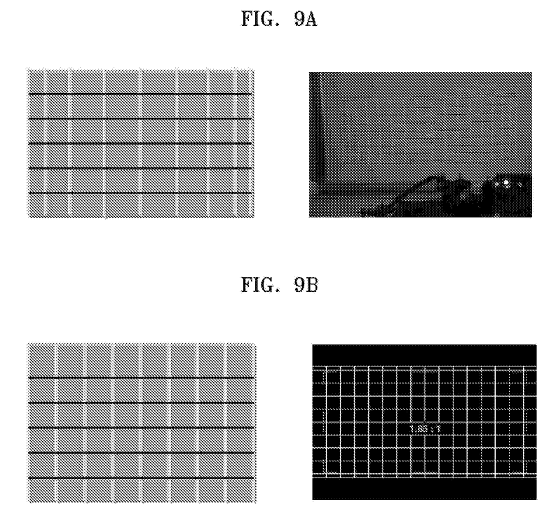

FIG. 9A is images showing a conventional line image that is distorted because the operational characteristic of a scanner is not compensated. Referring to FIG. 9A, according to the conventional technology, the distortion of the image, which is generated because of the linearity of a screen and the non-uniform motion of the scanner 170, is not compensated.

FIG. 9B is images showing a line image in which the operational characteristic of a scanner has been compensated according to an exemplary embodiment of the present invention. Referring to FIG. 9B, according to the exemplary embodiment of the present invention, the distortion of an image is not generated because the exemplary embodiment compensates for the linearity of a screen and the non-uniform motion of the scanner.

While this invention has been particularly shown and described with reference to exemplary embodiments thereof, it will be understood by those skilled in the art that various changes in form and details may be made therein without departing from the spirit and scope of the invention as defined by the appended claims.

The exemplary embodiments of the invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the exemplary embodiments of the present invention can be easily construed by programmers skilled in the art to which the present invention pertains.

As described above, according to the exemplary embodiments of the present invention, in a laser projection display system, since the output timing of the image data for driving a laser beam is adjusted based on the scanning operational characteristic of the scanner, the distortion of an image with respect to a non-linear motion of the scanner can be reduced.

What is claimed is:

1. A method for compensating a display distortion in a display system, the method comprising:
dividing a sync section where image data is output into a plurality of sections;
setting a clock speed of the image data for each of the sections based on an operational characteristic of a scanner; and
outputting the image data at a different clock speed for each divided section, the different clock speed reflecting a set clock speed for each divided section.

2. The method of claim 1, wherein the setting of the clock speed comprises:
setting a clock of a variety of speeds corresponding to the operational characteristic of the scanner for each divided section; and
selecting any one of the clocks of various speeds according to a speed control signal corresponding to each section.

3. The method of claim 1, wherein in the setting of the clock speed the clock speed is set to a variable clock according to a voltage controlled oscillator.

4. The method of claim 1, wherein the outputting of the image data comprises:
inputting image data of an odd line and writing the image data to a first memory according to a clock signal and a sync signal;
reading image data of a second memory at a data clock speed based on a speed of the scanner;
writing image data of an even line to the second memory according to the clock signal and the sync signal; and
reading image data of the first memory at a data clock speed based on a speed of the scanner.

5. An apparatus for compensating a display distortion in a display system, the apparatus comprising:
an image processor which extracts a sync signal and an image data from a composite image signal; and
a timing processor which stores image data according to a clock signal and the sync signal extracted by the image processor, dividing the stored image data of a predetermined section into a plurality of sections, and controlling output timing of the image data based on an operational speed of a scanner for each of the divided sections.

6. The method of claim 5, wherein the timing processor comprises:
first and second memories storing the image data; and
a memory control portion which inputs image data of an odd line and writes the image data to the first memory according to a clock signal and a sync signal, reads image data of the second memory at a data clock speed based on a speed of the scanner, writes image data of an even line to the second memory according to the clock signal and the sync signal, and reads image data of the first memory at a data clock speed based on a speed of the scanner.

7. A display system comprising:
an image signal processing portion which extracts a sync signal and image data from an input composite image signal and controls output timing of the extracted image data based on an operational characteristic of the scanner;
a light modulation portion which modulates the brightness of a light source according to an image signal output from the image processing portion; and
a scanner portion which scans a beam output from the light modulation portion onto a screen according to the sync signal generated by the image signal processing portion.

8. The display system of claim 7, wherein the image signal processing portion comprises:
an image processor which extracts a sync signal and an image data from a composite image signal; and
a timing processor which stores image data according to a clock signal and the sync signal extracted by the image processor, divides the stored image data of a predetermined section into a plurality of sections, and controls output timing of the image data based on an operational speed of a scanner for each of the divided sections.

9. The display system of claim 8, wherein the timing processor comprises:
a first memory;
a second memory; and
a memory control portion which inputs image data of an odd line and writes the image data to the first memory according to a clock signal and a sync signal, reads image data of the second memory at a data clock speed based on a speed of the scanner, writes image data of an even line to the second memory according to the clock signal and the sync signal, and reads image data of the first memory at a data clock speed based on a speed of the scanner.

10. The display system of claim 9, wherein the memory control portion comprises:
a phase locked loop (PLL) portion which divides an external clock signal into a plurality of clock signals; and
a multiplexer which selects any one of the clock signals generated by the phase locked loop according to a speed control signal of data output timing divided for each sync section.

11. The display system of claim 9, wherein the memory control portion further comprises a voltage controlled oscillator that generates a variable clock by a different voltage for each sync section.
